(19) United States
(12) Patent Application Publication
(10) Pub. No.: US 2011/0066519 A1
(43) Pub. Date: Mar. 17, 2011

(54) Facilitating data brokering arrangements having auctioning aspects

(76) Inventors: Gary W. Flake, Bellevue, WA (US); Royce A. Levien, Laxington, MA (US); Robert W. Lord, Seattle, WA (US); William Henry Mangione-Smith, Kirkland, WA (US); Richard F. Rashid, Redmond, WA (US); Clarence T. Tegreene, Bellevue, WA (US); Lowall L. Wood, JR., Bellevue, WA (US)

(21) Appl. No.: 12/804,770

(22) Filed: Jul. 27, 2010

Related U.S. Application Data
(63) Continuation-in-part of application No. 12/229,506, filed on Aug. 21, 2008.

(51) Int. Cl. G06Q 30/00

(52) U.S. Cl. 705/26.3

(57) ABSTRACT

Systems and methods for data brokering, and more specifically, data brokering regarding a data provider's search-related activities are described. In particular implementations, various aspects of offering the one or more data products to a plurality of potential data consumers for bid by the plurality of potential data consumers are described.

### CROSS REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)):

Related Applications:

For purposes of the United States Patent and Trademark Office (USPTO) extra-statutory requirements (described more fully below), the present application is:

1. For purposes of the USPTO extra-statutory requirements, the present application constitutes a continuation-in-part of U.S. patent application Ser. No. 12/217,138 entitled FACILITATING COMPENSATION ARRANGEMENTS FOR DATA BROKERING filed on Jun. 30, 2008 under Attorney Docket number SE1-0037-US, and naming Gary W. Flake, Royce A. Levien, Robert W. Lord, William Henry Mangione-Smith, Richard F. Rashid, Clarence T. Tegreene, and Lowell L. Wood, Jr. as inventors, which is currently co-pending, or is an application of which a currently co-pending application is entitled to the benefit of the filing date.

2. For purposes of the USPTO extra-statutory requirements, the present application constitutes a continuation-in-part of U.S. patent application Ser. No. 12/220,918 entitled FACILITATING COMPENSATION ARRANGEMENTS PROVIDING FOR DATA TRACKING COMPONENTS filed on Jul. 28, 2008 under Attorney Docket number SE1-0038-US, and naming Gary W. Flake, Royce A. Levien, Robert W. Lord, William Henry Mangione-Smith, Richard F. Rashid, Clarence T. Tegreene, and Lowell L. Wood, Jr. as inventors, which is currently co-pending, or is an application of which a currently co-pending application is entitled to the benefit of the filing date.

3. For purposes of the USPTO extra-statutory requirements, the present application constitutes a continuation-in-part of U.S. patent application Ser. No. 12/221,203 entitled FACILITATING COMPENSATION ARRANGEMENTS BETWEEN DATA PROVIDERS AND DATA CONSUMERS filed on Jul. 30, 2008 under Attorney Docket number SE1-0039-US, and naming Gary W. Flake, Royce A. Levien, Robert W. Lord, William Henry Mangione-Smith, Richard F. Rashid, Clarence T. Tegreene, and Lowell L. Wood, Jr. as inventors, which is currently co-pending, or is an application of which a currently co-pending application is entitled to the benefit of the filing date.

4. For purposes of the USPTO extra-statutory requirements, the present application constitutes a continuation-in-part of U.S. patent application Ser. No. 12/221,465 entitled FACILITATING COMPENSATION ARRANGEMENTS PROVIDING FOR DATA TRACKING COMPONENTS filed on Jul. 31, 2008 under Attorney Docket number SE1-0038C1-US, and naming Gary W. Flake, Royce A. Levien, Robert W. Lord, Henry Mangione-Smith, Richard F. Rashid, Clarence T. Tegreene, and Lowell L. Wood, Jr. as inventors, which is currently co-pending, or is an application of which a currently co-pending application is entitled to the benefit of the filing date.

5. For purposes of the USPTO extra-statutory requirements, the present application constitutes a continuation-in-part of U.S. patent application Ser. No. 12/229,506 entitled FACILITATING COMPENSATION ARRANGEMENTS HAVING PRIVACY PRESERVATION ASPECTS filed on Aug. 21, 2008 under Attorney Docket number SE1-0040-US, and naming Gary W. Flake, Royce A. Levien, Robert W. Lord, William Henry Mangione-Smith, Richard F. Rashid, Clarence T. Tegreene, and Lowell L. Wood, Jr. as inventors, which is currently co-pending, or is an application of which a currently co-pending application is entitled to the benefit of the filing date.

The United States Patent and Trademark Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003. The present applicant entity has provided a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### FIELD OF THE DISCLOSURE

The present disclosure relates generally to data brokering, and more specifically, to facilitating compensation arrangements having auctioning aspects.

### BACKGROUND

Individuals that engage in on-line activities, such as on-line search-related activities, typically generate information that may have value to other entities. Such information has often been surreptitiously monitored and gathered by various interested parties who, in turn, may make use of the information for commercial purposes (e.g. advertising).

### SUMMARY

The present disclosure teaches systems and methods for data brokering, and more specifically, data brokering regarding a data provider's search-related activities. In particular implementations, the present disclosure teaches facilitating compensation arrangements having auctioning aspects.

### BRIEF DESCRIPTION OF THE DRAWINGS

FIG. 1 is a schematic view of a representative environment for brokering data in accordance with an implementation of the present disclosure.

FIG. 2 is a schematic view of an exemplary computing device configured to operate in accordance with another implementation of the present disclosure.

FIG. 3 is a flowchart of a method of brokering data in accordance with another implementation of the present disclosure.

FIGS. 4 through 12 are flowcharts of methods of facilitating compensation arrangements between data providers and data consumers in accordance with further implementations of the present disclosure.

### DETAILED DESCRIPTION

Techniques for brokering data regarding a data provider's search-related activities are disclosed. It should be appreciated that many specific details of certain implementations are set forth in the following description, and shown in the accompanying figures, to provide a thorough understanding of such implementations. One skilled in the art will understand from the teachings of the present disclosure, however, that the present disclosure may have other possible implementations, and that such other implementations may be practiced with/without some of the details set forth in the following description.

In the following discussion, an exemplary environment 100 for implementing one or more of the teachings of the present disclosure is described. Next, an exemplary computing device 200 for implementing one or more of the teachings of the present disclosure is described, followed by a description of various possible implementations of processes for data brokering in accordance with various implementations of the present disclosure.

Exemplary Environment

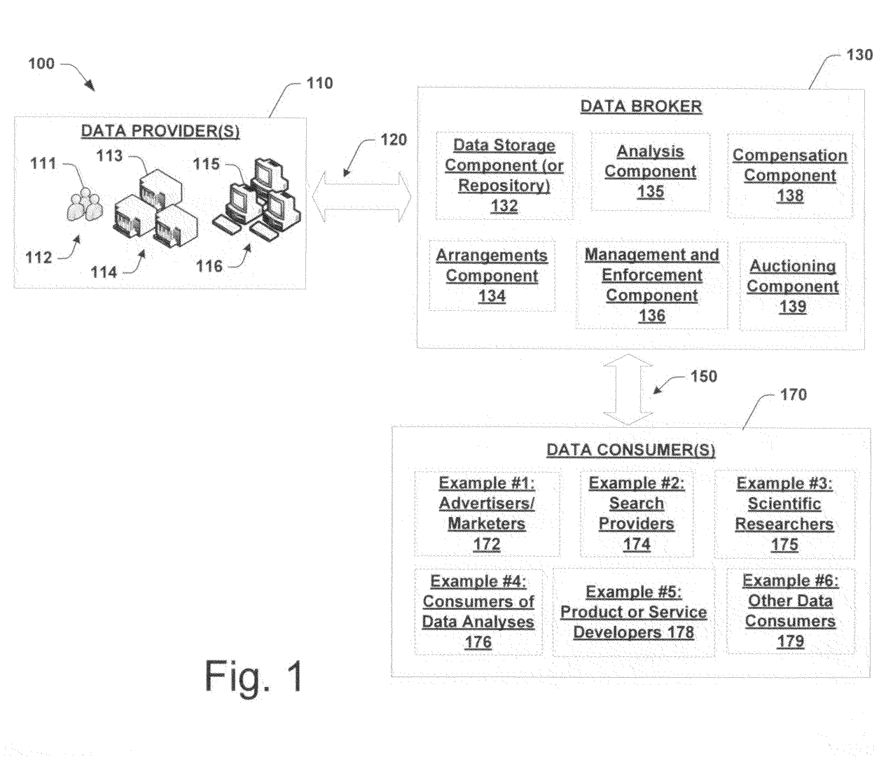

FIG. 1 is a schematic view of a representative environment 100 in accordance with an implementation of the present disclosure. In this implementation, the environment 100 includes one or more data providers 110, and one or more data consumers 170 who use the data generated by the data providers 110. In general, the data (or data products) generated by the data providers 110 may include a wide variety of information, including keywords, phrases, search terms, Universal Resource Locator (URL) data, browsing history, eyeballing history, time and quantity information, selection history, affinity-related information, health-related information, consumer-related information, personal-characteristic information, corporate (or other business entity) information, and any other suitable information.

The data providers 110 may include a variety of different providers and provider types. For example, in various implementations, the data providers 110 may include an individual 111, a group of individuals 112, an entity 113, a group of entities 114, a device 115, or a group of devices 116. In general, virtually any individual, entity, device, or groups thereof, may be a member of the data providers 110. For example, in various implementations, the individual 111 (or group of individuals 112) may include a computer user, consumer, person from a particular demographic group (e.g. age, gender, race, profession, religion, orientation, preference, geographic area, etc.), a particular bellwether or trendsetting individual (e.g. individual with popular ideas or tastes, athlete, performing artist, etc.), or any other suitable person.

Similarly, in various implementations, the entity 113 (or group of entities 114) may include a professional organization (e.g. Institute of Electrical and Electronics Engineers (IEEE), American Automobile Association (AAA), American Association of Retired Persons (AARP), etc.), company, university, union (e.g. United Auto Workers (UAW), International Affiliation of Writers Guilds, European Patent Lawyers Association (EPLA), etc.), consumer group (e.g. members of Costco®, Sam's Club®, Starwood®, etc.), club, association, (e.g. Boy Scouts of America, etc.), or any other suitable type of entity. Also, in various implementations, the device 115 (or group of devices 116) may include, for example, a computer, networking device, processor, personal communication device, or any other suitable type of device. Of course, other individuals, entities, and devices that may serve as data providers 110 may be conceived. More specifically, in particular implementations, any individual, entity, or device whose data may serve as an indicator of future consumption may suitably qualify such individual, entity, or device as a data provider 110.

The data consumers 170 may also include a variety of different consumers and consumer types. For example, in some specific implementations, the data consumers 170 may include advertisers or marketers 172, search providers 174, scientific researchers 175, consumers of data analyses 176, product or service developers 178, or any other data consumers 179. Data consumers 170 may also include any and all of the individuals, entities, and devices (or groups thereof) referenced above as data providers 110, or any other suitable types of data consumers. It will be appreciated that the data providers 110 and the data consumers 170 are not necessarily mutually exclusive groups, and that an entity may in some instances be a data provider, and in other instances a data consumer, or may even be both at the same time.

As further shown in FIG. 1, a data broker 130 operatively communicates with the one or more data providers 110 and the one or more data consumers 170. For example, communications (or interactions) 120 may be exchanged between the data broker 130 and the one or more data providers 110. The communications 120 may include, in some implementations, negotiation activities (e.g. offers, rejections, counteroffers, terms, conditions, provisions, etc.) which may lead to the establishment of one or more data provision agreements between the data providers 110 and the data broker 130. The communications 120 may also include communications relating to performance of established data provision agreements, including, for example, data transmissions, data receptions, access records, compensation exchanges, accounting exchanges, or any other suitable communications (or interactions) relating to data brokering.

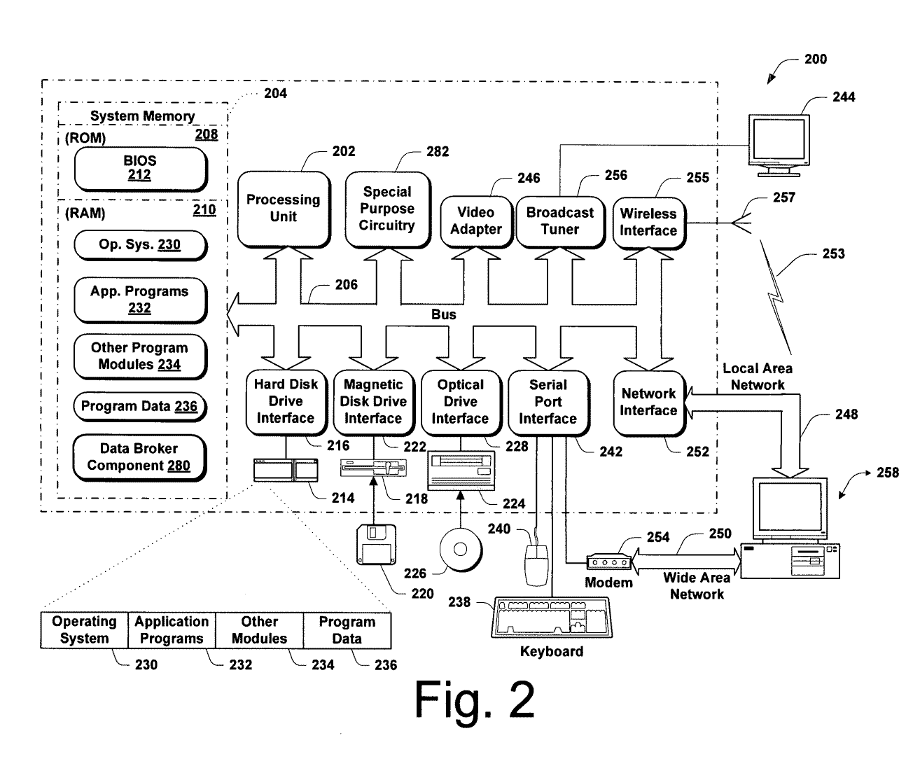

Such communications 120 may be exchanged via any suitable communications systems. For example, in some implementations the communications 120 may be exchanged via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems. Further, the communications 120 may be accomplished using any suitably operable couplings between the data broker 130 and the one or more data providers 110, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using one or more components of an exemplary computing device, such as a network interface, a wireless interface, a serial port interface, or any other suitable components (e.g. components or interfaces 216, 222, 228, 252, 242, 255 of FIG. 2).

Similarly, communications (or interactions) 150 between the data broker 130 and the one or more data consumers 170 may include, for example, negotiation activities (e.g. offers, rejections, counteroffers, terms, conditions, provisions, etc.) which may lead to the establishment of one or more data use agreements between the data providers 110 and the data broker 130. Also, the communications 150 may include communications relating to performance of established data use agreements, including, for example, data transmissions, data receptions, access records, compensation exchanges, accounting exchanges, or any other suitable communications (or interactions) relating to data brokering.

Again, such communications 150 may be exchanged via any suitable communications systems. For example, in some implementations the communications 150 may be exchanged via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems. Further, the communications 150 may be accomplished using any suitably operable couplings between the data broker 130 and the one or more data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using one or more components of an exemplary computing device, such as a network interface, a wireless interface, a serial port interface, or any other suitable components (e.g. components or interfaces 216, 222, 228, 252, 242, 255 of FIG. 2).

In some implementations, the data broker 130 may include one or more components that are operable to perform various functions and operations associated with the data broker 130. For example, the data broker 130 may include a data storage component 132, an arrangements component 134, an analysis component 135, a management and enforcement component 136, a compensation component 138, and an auctioning component 139. It will be appreciated that the components of the data broker 130 shown in FIG. 1 are merely exemplary, and represent a possible implementation of the data broker 130. The functions and operations of the components 132-139 of the data broker 130 will be described more fully below.

In the implementation shown in FIG. 1, the various components 132-139 of the data broker 130 may communicate and exchange information as needed to perform the functions and operations described herein. In various implementations, each of the components 132-139 may be implemented using software, hardware, firmware, or any suitable combinations thereof. It will be appreciated that in alternate implementations of the data broker 130, one or more of the components 132-139 of the data broker 130 may be combined, or may be divided or separated into additional components, or additional components may be added, or one or more of the components 132-139 may simply be eliminated, depending upon the particular requirements or specifications of the operating environment. An exemplary computing device 200 for carrying out one or more of the functions and operations of the environment 100 is described in the following section.

Exemplary Computing Device

In some implementations, one or more of the components of the exemplary environment 100 shown in FIG. 1 may be at least partially implemented using a computing device. For example, FIG. 2 is a schematic view of an exemplary computing device 200 configured to operate in accordance with an implementation of the present disclosure. As described below, the computing device 200 can be configured to perform one or more of the functions and operations associated with the environment 100 shown in FIG. 1, and more specifically, one or more of the functions and operations associated with the data broker 130, or the one or more components 132-139 of the data broker 130.

As shown in FIG. 2, in some implementations, the computing device 200 may include one or more processors (or processing units) 202, special purpose circuitry 282, a memory 204, and a bus 206 that couples various system components including the memory 204 to the one or more processors 202 and special purpose circuitry 282. The bus 206 represents one or more of any of several types of bus structures, including a memory bus or memory controller, a peripheral bus, an accelerated graphics port, and a processor or local bus using any of a variety of bus architectures. In this implementation, the memory 204 includes read only memory (ROM) 208 and random access memory (RAM) 210. A basic input/output system (BIOS) 212, containing the basic routines that help to transfer information between elements within the computing device 200, such as during start-up, is stored in ROM 208.

The exemplary computing device 200 further includes a hard disk drive 214 for reading from and writing to a hard disk (not shown), and is connected to the bus 206 via a hard disk driver interface 216 (e.g., a SCSI, ATA, or other type of interface). A magnetic disk drive 218 for reading from and writing to a removable magnetic disk 220, is connected to the system bus 206 via a magnetic disk drive interface 222. Similarly, an optical disk drive 224 for reading from or writing to a removable optical disk 226 such as a CD ROM, DVD, or other optical media, connected to the bus 206 via an optical drive interface 228. The drives and their associated computer-readable media provide nonvolatile storage of computer readable instructions, data structures, program modules and other data for the computing device 200. Although the exemplary computing device 200 described herein employs a hard disk, a removable magnetic disk 220 and a removable optical disk 226, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used.

As further shown in FIG. 2, a number of program modules may be stored on the memory 204 (e.g. the ROM 208 or the RAM 210) including an operating system 230, one or more application programs 232, other program modules 234, and program data 236. Alternately, these program modules may be stored on other computer-readable media, including the hard disk, the magnetic disk 220, or the optical disk 226. For purposes of illustration, programs and other executable program components, such as the operating system 230, are illustrated in FIG. 2 as discrete blocks, although it is recognized that such programs and components reside at various times in different storage components of the computing device 200, and may be executed by the processor(s) 202 or the special purpose circuitry 282 of the computing device 200.

A user may enter commands and information into the computing device 200 through input devices such as a keyboard 238 and a pointing device 240. Other input devices (not shown) may include a microphone, joystick, game pad, satellite dish, scanner, or the like. These and other input devices are connected to the processing unit 202 and special purpose circuitry 282 through an interface 242 that is coupled to the system bus 206. A monitor 244 or other type of display device is also connected to the bus 206 via an interface, such as a video adapter 246. In addition to the monitor, the computing device 200 may also include other peripheral output devices (not shown) such as speakers and printers.

The computing device 200 may operate in a networked environment using logical connections to one or more remote computers (or servers) 258, such as those operated by one or more of the data providers 110 and data consumers 170 shown in FIG. 1. Such remote computers (or servers) 258 may be a personal computer, a server, a router, a network PC, a peer device or other common network node, and may include many or all of the elements described above relative to computing device 200. The logical connections depicted in FIG. 2 (and in FIG. 1) may include one or more of a local area network (LAN) 248 and a wide area network (WAN) 250. Such networking environments are commonplace in offices, enterprise-wide computer networks, intranets, and the Internet. In this embodiment, the computing device 200 also includes one or more broadcast tuners 256. The broadcast tuner 256 may receive broadcast signals directly (e.g., analog or digital cable transmissions fed directly into the tuner 256) or via a reception device (e.g., via an antenna, a satellite dish, etc.).

When used in a LAN networking environment, the computing device 200 may be connected to the local network 248 through a network interface (or adapter) 252. When used in a WAN networking environment, the computing device 200 typically includes a modem 254 or other means for establishing communications over the wide area network 250, such as the Internet. The modem 254, which may be internal or external, may be connected to the bus 206 via the serial port interface 242. Similarly, the computing device 200 may exchange (send or receive) wireless signals 253 with one or more remote computers (or servers) 258, such as those operated by one or more of the data providers 110 and data consumers 170, using a wireless interface 255 coupled to a wireless communicator 257 (e.g., an antenna, a satellite dish, a transmitter, a receiver, a transceiver, a photoreceptor, a photodiode, an emitter, a receptor, etc.).

In a networked environment (e.g. environment 100 of FIG. 1), program modules depicted relative to the computing device 200, or portions thereof, may be stored in the memory 204, or in a remote memory storage device. More specifically, as further shown in FIG. 2, a data broker component 280 may be stored in the memory 204 of the computing device 200. The data broker component 280 may include an implementation of the data broker 130 of FIG. 1, or one or more components 132-139 of the data broker 130. The data broker component 280 may be implemented using software, hardware, firmware, or any suitable combinations thereof. In cooperation with the other components of the computing device 200, such as the processing unit 202 or the special purpose circuitry 282, the data broker component 280 may be operable to perform one or more implementations of processes for data brokering in accordance with the present disclosure. More specifically, the computing device 200 may be operable to perform one or more implementations of methods of brokering data, as described more fully below.

Exemplary Processes for Data Brokering

Exemplary processes for brokering data regarding a data provider's search-related activities will now be described. For convenience, and to facilitate an understanding of these processes, the exemplary processes will be described with reference to the exemplary environment 100 and exemplary computing device 200 described above.

As noted above, the data broker 130 (FIG. 1) may include one or more components that are operable to perform various functions and operations associated with the data broker 130. More specifically, in the exemplary implementation of the data broker 130 shown in FIG. 1, the data broker 130 includes a data storage component or repository 132, an arrangements component 134, an analysis component 135, a management and enforcement component 136, a compensation component 138, and an auctioning component 139. Of course, in alternate implementations, one or more of these components 132-139 may be combined, separated into additional components, or eliminated, or additional components may be added, depending upon the particular requirements or specifications of the operating environment.

Various exemplary functionalities of the components 132-139 of the exemplary data broker 130 will now be described. It should be appreciated that the exemplary functionalities described below may be desirable in some implementations but not in others, and that unless otherwise specified, such exemplary functionalities are non-essential, and may be varied or omitted depending upon the desired operating characteristics of the implementation, or the particular requirements or specifications of the operating environment.

In some implementations, the data storage component 132 may be operable to receive and store data provided by the data providers 110. The data storage component 132 may organize the data by type, profile, data provider, value, or using any other suitable organizational structure. In some implementations, the data storage component 132 may perform verification activities, including monitoring and analyzing incoming data to ensure verity (e.g. accuracy, authenticity, etc.) of the information provided by the data providers 110.

In some implementations, the data provided by the data providers 110 may be included as part of the communications 120 described above. Furthermore, the data provided by the data providers 110 may be provided in any suitable form, including electrical signals, optical signals, acoustic signals, electromagnetic signals, modulated signals (e.g. frequency or amplitude modulated signals, etc.), binary signals, tabulated data, data records, data summaries, or any other suitable forms, and may be provided using any suitable communication media, including physical media (e.g. wires, cables, optical connectors, CD's, DVD's, printed or written data, etc.) non-physical transmission media (e.g. wireless transmissions), or any other suitable communication systems or methods.

In some implementations, the data storage component 132 may store additional information relating to the communications 120, 150 between the data broker 130 and the data providers 110 and the data consumers 170. For example, the data storage component 132 may store information relating to the functions and operations of any of the other components 134-139 of the data broker 130, including, for example, negotiation activities (e.g. offers, rejections, counteroffers, terms, conditions, provisions, etc.), established data provision agreements and data use agreements (e.g. terms and conditions regarding access, compensation, privacy, quality, quantity, usage, rights and restrictions, etc.), and information relating to performance of such established agreements (e.g. data transmissions, data receptions, access records, compensation exchanges, accounting exchanges, etc.). Various aspects of possible functions and operations of the other components 134-139 of the data broker 130 that may be stored within the data storage component 132 are described below.

Similarly, the arrangements component 134 may be operable to perform a variety of functions and operations associated with the data broker 130 via the communications 120, 150 between the data broker 130 and the data providers 110 and the data consumers 170. For example, in some implementations, the arrangements component 134 may be operable to perform negotiations of data brokering arrangements, including one or more of data provision agreements with data providers 110, or data use agreements with data consumers 170.

More specifically, in some implementations, the arrangements component 134 may be operable to create proposals, propose terms, receive offers to provide data, receive offers to consume data, receive requests for data analyses, identify potential data providers, identify potential data consumers, and perform other functions and operations associated with making arrangements with the data providers 110, the data consumers 170, or both. Additional aspects of data brokering that may be negotiated or performed by the arrangements component 134 are described below.

The analysis component 135 (FIG. 1) may also be operable to perform a variety of functions and operations associated with the data broker 130. For example, the analysis component 135 may be operable to perform an analysis or simulation using one or more components of the computing device 200 (e.g. the processing unit 202, the special purpose circuitry 282, the memory 204, the application programs 232, the program modules 234, the program data 236, etc.).

More specifically, in some implementations, the analysis component 135 may be operable to perform a desired analysis or simulation in response to a request by one or more of the data consumers 170 (or the data providers 110, or the data broker 130), such as to test a theory, to determine a potential value of data, to develop or validate a new model or hypothesis, to filter or glean relevant data from a quantity of raw data, or to perform any other suitable analysis or simulation. For example, the analysis component 135 may, at the request of one or more of the data consumers 170 (or the data providers 110, or the data broker 130) perform desired analyses or simulations, including mathematical manipulations of the data (e.g. interpolations, extrapolations, correlations, data fitting analyses, linear regressions, mathematical combinations, statistical analyses, Fourier analyses, Bayesian analyses, time-series analyses, etc.), model validation activities, model test activities, model development activities of suitable models (e.g. marketing models, consumption models, business models, economic models, etc.) that may use the data provided by the data providers 110.

The management and enforcement component 136 (FIG. 1) may be operable to monitor a performance of one or more of the data providers 110, the data broker 130, or the data consumers 170, in accordance with the arrangements established by the arrangements component 134. In some implementations, the management and enforcement component 136 may monitor performance by analyzing the communications 120 between the data providers 110 and the data broker 130, or the communications 150 between the data broker 130 and the data consumers 170. In other implementations, the management and enforcement component 136 may monitor the operations of one or more of the other components of the data broker 130 (e.g. the data storage component 132, the analysis component 135, the compensation component 138, etc.).

More specifically, the management and enforcement component 136 may perform one or more monitoring functions (e.g. access requests, traffic volumes, access periods, access volumes, consumer and provider identities, hits, usage rates, provision rates, etc.), recordkeeping functions (e.g. access requests, traffic volumes, access periods, access volumes, consumer and provider identities, hits, usage rates, provision rates, etc.), access control functions (e.g. data rights management, license terms, restrictions on usage, privacy and confidentiality provisions, etc.), notification functions including transmitting alerts, warnings, reminders, and notices regarding terms and conditions of data brokering agreements (e.g. usage rates and limits, provision rates and limits, spending rates and limits, quality assurance, usage restrictions, privacy restrictions, etc.), or any other suitable functions in accordance with the terms and conditions of the agreements established between the parties.

The functions and operations of the management and enforcement component 136 may be performed using software (e.g. traffic monitoring software, speed monitoring software, transfer rates recorder, bandwidth usage software, keystroke monitoring, etc.) that monitors, records, or captures upload and download activities (e.g. at one or more interfaces of a computing device 200, at the processor 202, at the memory 204, etc.), hardware (e.g. counters, meters, network cards, circuitry, etc.), firmware, or any suitable combination thereof.

With continued reference to FIG. 1, the compensation component 138 may be operable to determine the various amounts of compensation due from one or more of the data consumers 170, or to determine the various amounts of compensation owing to on or more of the data providers 110, or both. For example, the compensation component 138 may be operable to determine compensation due or owing using one or more components of the computing device 200 (e.g. the processing unit 202, the special purpose circuitry 282, the memory 204, the application programs 232, the program modules 234, the program data 236, etc.).

In some implementations, the compensation component 138 may receive instructions or information to be used in determining compensation due or owing from one or more other components of the data broker 130. For example, in some implementations, the compensation component 138 may receive terms or instructions regarding compensation established by the arrangements component 134 (or the auctioning component 139). Similarly, the compensation component 138 may receive performance information from one or more other components of the data broker 130, including performance information from the management and enforcement component 136, the data storage component 132, the analysis component 135, or any other suitable component. In further implementations, the compensation component 138 may be operable to manage and implement a variety of compensation types, including upfront compensation, future compensation, contingent or conditional compensation, royalty-based compensation, auctioning-based compensation, non-monetary compensation, or any other suitable types of compensation. The compensation determined by the compensation component 138 may be provided by one or more of the communications 120 between the data providers 110 and the data broker 130, or the communications 150 between the data broker 130 and the data consumers 170.

The auctioning component 139 (FIG. 1) may be operable to perform functions and operations associated with the auctioning of data. For example, in some implementations, the auctioning component 139 may function in a manner substantially similar to the arrangements component 134, but may be operable to do so in an auctioning format. The auctioning component 139 may be operable to perform a variety of functions and operations associated with the data broker 130 via the communications 120, 150 between the data broker 130 and the data providers 110 and the data consumers 170. For example, in some implementations, the auctioning component 139 may be operable to perform negotiations of data brokering arrangements, including one or more of arranging or negotiating data provision agreements with data providers 110 via the communications 120, or arranging or negotiating data use agreements with data consumers 170 via the communications 150.

In some implementations, the auctioning component 139 may be operable to offer data products to a plurality of potential data consumers, to receive bids for use of the data, to evaluate the bids, to negotiate the terms and conditions, and to perform any other suitable auction-related functions. The auctioning component 139 may also be configured to create proposals, propose terms, receive offers to provide data, receive offers to consume data, receive requests for data analyses, identify potential data providers, identify potential data consumers, perform negotiations of one or more of data provision agreements and data use agreements, and perform other functions and operations associated with making arrangements with the data providers 110 and the data consumers 170.

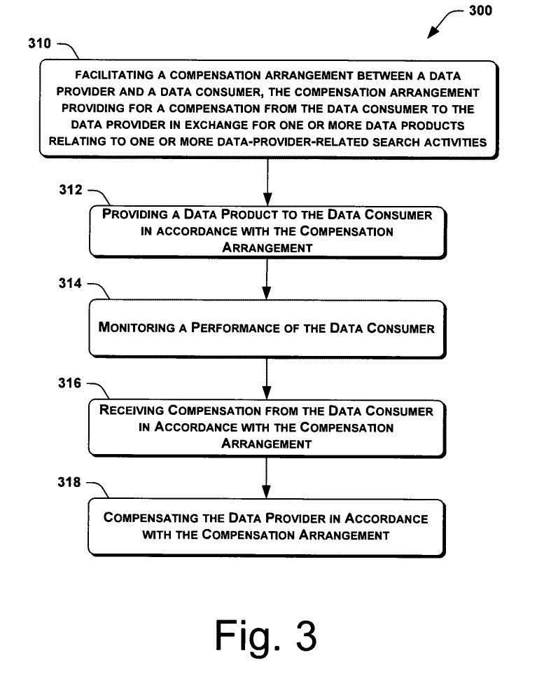

Additional aspects of data brokering processes in accordance with various possible implementations of the present disclosure will now be described with reference to FIGS. 3 through 12. For ease of understanding, the flowcharts are organized such that the initial flowchart (FIG. 3) presents an overall “big picture” viewpoint, and thereafter the following flowcharts present possible particular implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and efficient understanding of the various process instances.

FIG. 3 is a flowchart of a method of brokering data 300 in accordance with another implementation of the present disclosure. In this implementation, the method 300 includes facilitating a compensation arrangement between a data provider and a data consumer, the compensation arrangement providing for a compensation from the data consumer to the data provider in exchange for one or more data products relating to one or more data-provider-related search activities at 310 (e.g. negotiating for monetary payments to be paid to an individual by an advertiser in exchange for access to the individual's online search terms; agreeing to provide a discount on goods or services to members of an association in exchange for access to information related to browsing histories of the association's members; providing access to scientific literature to a group of scientists by a seller of scientific supplies in exchange for authorization to gather data regarding the group's accessing of the scientific literature; etc.). In some implementations, facilitating a compensation arrangement between a data provider and a data consumer, the compensation arrangement providing for a compensation from the data consumer to the data provider in exchange for one or more data products relating to one or more data-provider-related search activities (at 310) may be performed by the data broker 130, or more specifically by one or more components of the data broker 130 (e.g. the arrangements component 134, the auctioning component 139, etc.).

Generally, facilitating a compensation arrangement between a data provider and a data consumer, the compensation arrangement providing for a compensation from the data consumer to the data provider in exchange for one or more data products relating to one or more data-provider-related search activities (at 310), as well as other portions of the method 300 described herein, may be accomplished using the communications 120 between the data providers 110 and the data broker 130, or the communications 150 between the data broker 130 and the data consumer 170, or both. Additionally, in some implementations, facilitating a compensation arrangement between a data provider and a data consumer, the compensation arrangement providing for a compensation from the data consumer to the data provider in exchange for one or more data products relating to one or more data-provider-related search activities (at 310), as well as other portions of the method 300 described herein, may be accomplished via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems.

It will also be appreciated that facilitating a compensation arrangement between a data provider and a data consumer, the compensation arrangement providing for a compensation from the data consumer to the data provider in exchange for one or more data products relating to one or more data-provider-related search activities (at 310), as well as other portions of the method 300 described herein, may be accomplished using any suitably operable couplings between the data broker 130 and the one or more data providers 110 and data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using computing devices (e.g. computing device 200, servers, laptops, mainframes, personal data assistants, cell phones, etc.), or using one or more components of such devices (e.g. processers 202, special purpose circuitry 282, application programs 232, other program modules 234, program data 236, network interface 252, wireless interface 255, serial port interface 242, other interfaces 216, 222, 228, etc.).

As further shown in FIG. 3, the method 300 may include providing a data product to the data consumer in accordance with the compensation arrangement at 312 (e.g. allowing a data consumer to access a specified quantity of search-related information stored in a data repository; transmitting a computer user's search terms to a marketing consultant on a periodic basis; downloading a browsing history to an online retailer in pre-determined increments, providing an RSS feed of online search activities to an advertiser in a real-time manner, etc.). In some implementations, providing a data product to the data consumer in accordance with the compensation arrangement may be performed by the data broker 130, or more specifically, by one or more components of the data broker 130 (e.g. the data storage component 132, the arrangements component 134, the management and enforcement component 136, the auctioning component 139, etc.).

In some implementations, the method 300 may include monitoring a performance of the data consumer at 314 (e.g. detecting a quantity of search-related information accessed by the data consumer; monitoring a benefit realized by a marketer attributable (or presumably attributable) to data provided to the marketer; measuring an increase in “hits” experienced by an online retailer; sensing a quantum of information analyzed by or on behalf of the data consumer; etc.). In general, monitoring a performance of the data consumer (at 314) may be performed using software that monitors, records, or captures a user's activities (e.g. traffic monitoring software, speed monitoring software, transfer rates recorder, bandwidth usage software, keystroke monitoring, etc.), hardware (e.g. counters, meters, network cards, circuitry, etc.), firmware, or any suitable combination thereof. More specifically, monitoring a performance of the data consumer (at 314) may include one or more of monitoring activities (e.g. access requests, traffic volumes, access periods, access volumes, consumer and provider identities, hits, usage rates, provision rates, etc.), recordkeeping activities (e.g. access requests, traffic volumes, access periods, access volumes, consumer and provider identities, hits, usage rates, provision rates, etc.), access control activities (e.g. data rights management, license terms, restrictions on usage, privacy and confidentiality provisions, etc.), notification activities (e.g. transmitting alerts, warnings, reminders, notices, rates and limits, quality assurance, restrictions, etc.), capturing activities, or any other suitable functions in accordance with the terms and conditions of one or more of the agreements established between the parties. Furthermore, in some implementations, the monitoring a performance of the data consumer (at 314) may occur at any suitable location within the environment 100 (e.g. at one or more interfaces of a computing device 200, at the processor 202, at the memory 204, etc.).

With continued reference to FIG. 3, the method 300 may also include receiving compensation from the data consumer in accordance with the compensation arrangement at 316. For example, in some implementations, receiving compensation from the data consumer in accordance with the compensation arrangement (at 316) may be accomplished using electronic (wire or wireless) transfers of funds, electronic payments, credits and debit transactions, transmittals of checks or other negotiable instruments, or any other suitable methods of compensation exchange. In some implementations, receiving compensation from the data consumer in accordance with the compensation arrangement (at 316) may be accomplished using the communications 150 between the data broker 130 and the data consumers 170. More specifically, the compensation may be received from the data consumer 170 by the data broker 130, or by one or more components of the data broker 130 (e.g. the management and enforcement component 136, the compensation component 138, the arrangements component 134, the auctioning component 139, or any other suitable component).

The method 300 may also include compensating the data provider in accordance with the compensation arrangement at 318. Again, in some implementations, compensating the data provider in accordance with the compensation arrangement (at 318) may be accomplished using electronic (wire or wireless) transfers of funds, electronic payments, credits and debit transactions, transmittals of checks or other negotiable instruments, or any other suitable methods of compensation exchange. More specifically, the compensation may be provided to the data provider 110 by the data broker 130, or by one or more components of the data broker 130 (e.g. the management and enforcement component 136, the compensation component 138, the arrangements component 134, the auctioning component 139, or any other suitable component).

As noted above, in some implementations, one or more of the above-referenced portions of methods in accordance with the present disclosure (e.g. method 300) may be accomplished using the communications 120 between the data broker 130 and the data providers 110. Additionally, one or more of the above-referenced portions of methods in accordance with the present disclosure (e.g. portions 310-318 of method 300) may be accomplished via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems, and may be accomplished using any suitably operable couplings between the data broker 130 and the one or more data providers 110 and data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using computing devices (e.g. computing device 200, servers, laptops, mainframes, personal data assistants, cell phones, etc.), or using one or more suitable components of such devices (e.g. processers 202, special purpose circuitry 282, application programs 232, other program modules 234, program data 236, network interface 252, wireless interface 255, serial port interface 242, other interfaces 216, 222, 228, etc.), or any other suitable methods or systems.

Exemplary Processes for Facilitating Compensation Arrangements

The preceding description has presented an exemplary “big picture” overview of possible implementations of processes in accordance with the present disclosure. In the following discussion, additional details of exemplary particular implementations are described. More specifically, it will be appreciated that facilitating a compensation arrangement between a data provider and a data consumer, the compensation arrangement providing for a compensation from the data consumer to the data provider in exchange for one or more data products relating to one or more data-provider-related search activities (e.g. at 310 of the exemplary method 300 of FIG. 3) may be implemented in a variety of ways.

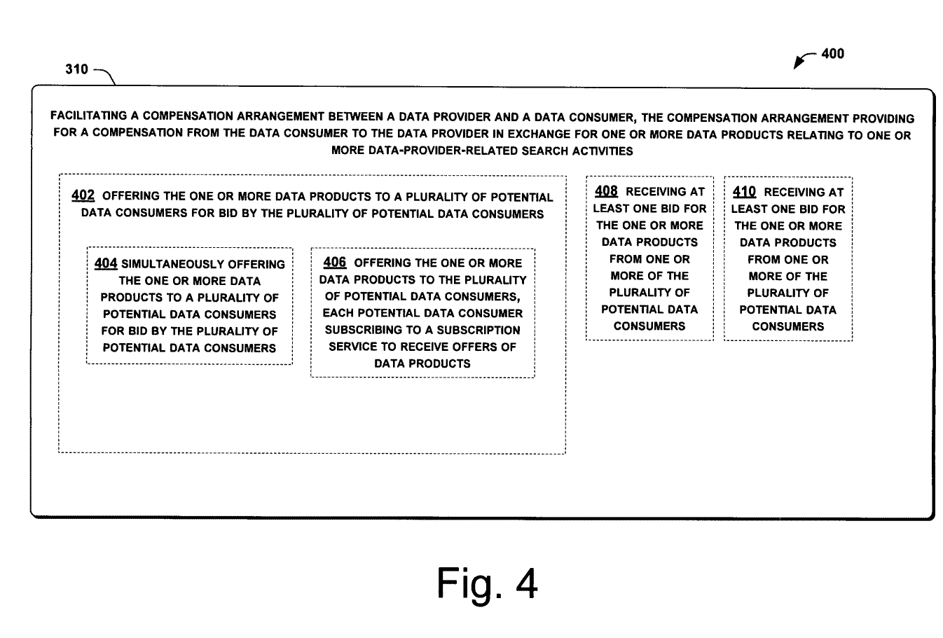

For example, as shown in FIG. 4, in an implementation 400, facilitating a compensation arrangement between a data provider and a data consumer, the compensation arrangement providing for a compensation from the data consumer to the data provider in exchange for one or more data products relating to one or more data-provider-related search activities (at 310 of FIG. 3) may include offering the one or more data products to a plurality of potential data consumers for bid by the plurality of potential data consumers at 402 (e.g. magazine advertisements, electronic or non-electronic mailings, oral or written solicitations, etc.). For example, in some implementations, the offering the one or more data products to a plurality of potential data consumers for bid by the plurality of potential data consumers at 402 simultaneously offering the one or more data products to a plurality of potential data consumers for bid by the plurality of potential data consumers at 404 (e.g. public or private auctioning to selected groups of advertisers, market researchers, consultants, government entities, etc.).

Similarly, in some implementations, offering the one or more data products to a plurality of potential data consumers for bid by the plurality of potential data consumers (at 402) may include offering the one or more data products to the plurality of potential data consumers, each potential data consumer subscribing to a subscription service to receive offers of data products at 406 (e.g. subscribers to announcements of data offerings from selected demographic populations, employers, governmental entities, researchers, consultants, companies, etc.).

In further implementations, facilitating a compensation arrangement between a data provider and a data consumer, the compensation arrangement providing for a compensation from the data consumer to the data provider in exchange for one or more data products relating to one or more data-provider-related search activities (at 310) may include receiving at least one bid for the one or more data products from one or more of the plurality of potential data consumers at 408 (e.g. receiving an offer of monetary payment for data on a particular demographic population from a seller of goods, receiving an offer of data exchange for browsing information by employees of a company or field from a provider of services, etc.).

Similarly, in some implementations, facilitating a compensation arrangement between a data provider and a data consumer, the compensation arrangement providing for a compensation from the data consumer to the data provider in exchange for one or more data products relating to one or more data-provider-related search activities (at 310) may include receiving a plurality of bids for the one or more data products from a corresponding plurality of potential data consumers at 410 (e.g. receiving multiple offers to purchase data from multiple of buyers, etc.).

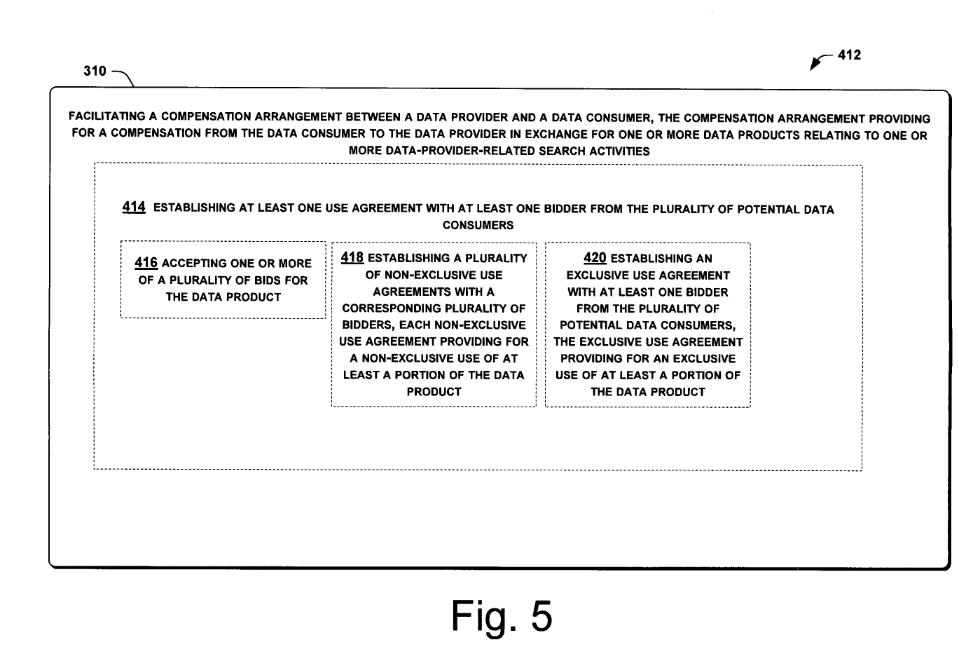

FIG. 5 shows another implementation 412 in accordance with the teachings of the present disclosure. As shown in FIG. 5, in some implementations, facilitating a compensation arrangement between a data provider and a data consumer, the compensation arrangement providing for a compensation from the data consumer to the data provider in exchange for one or more data products relating to one or more data-provider-related search activities (at 310) may include establishing at least one use agreement with at least one bidder from the plurality of potential data consumers at 414 (e.g. entering into a purchase agreement for data on a particular demographic group with a highest bidder, entering into a license agreement for data on a group of employee's browsing information with those bidders in the top 20% of all bidders, etc.). For example, in some implementations, establishing at least one use agreement with at least one bidder from the plurality of potential data consumers (at 414) may include accepting one or more of a plurality of bids for the data product at 416 (e.g. accepting the top five bids for browsing data from a group of greater than five bids, accepting the top 10% of all bids, etc.).

Similarly, in further implementations, establishing at least one use agreement with at least one bidder from the plurality of potential data consumers (at 414) may include establishing a plurality of non-exclusive use agreements with a corresponding plurality of bidders, each non-exclusive use agreement providing for a non-exclusive use of at least a portion of the data product at 418 (e.g. establishing a plurality of non-exclusive license agreements for using advertising-response data for a particular group of persons, etc.).

In other implementations, establishing at least one use agreement with at least one bidder from the plurality of potential data consumers (at 414) may include establishing an exclusive use agreement with at least one bidder from the plurality of potential data consumers, the exclusive use agreement providing for an exclusive use of at least a portion of the data product at 420 (e.g. establishing an exclusive license agreement with a market research entity for using advertising-response data for a particular group of persons, etc.).

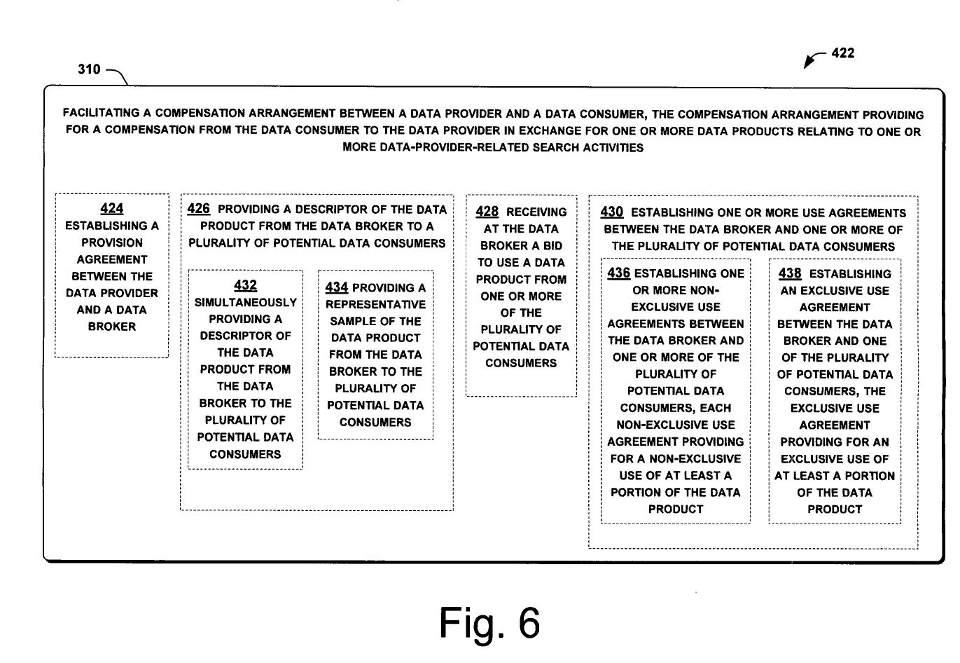

FIG. 6 shows another implementation 422 in accordance with the teachings of the present disclosure. As shown in FIG. 6, in some implementations, facilitating a compensation arrangement between a data provider and a data consumer, the compensation arrangement providing for a compensation from the data consumer to the data provider in exchange for one or more data products relating to one or more data-provider-related search activities (at 310) may include establishing a provision agreement between the data provider and a data broker at 424 (e.g. establishing an agreement between a product manufacturing company to provide data regarding browsing activity persons of a particular demographic group to an entity that re-sells access to such information to various third-party licensees, etc.), providing a descriptor of the data product from the data broker to a plurality of potential data consumers at 426 (e.g. announcing an availability of browsing activity data by persons of a particular demographic group to advertising and/or marketing companies interested in selling goods or services to persons of a particular demographic group, etc.), receiving at the data broker a bid to use a data product from one or more of the plurality of potential data consumers at 428 (e.g. receiving a first offer of monetary payment from a marketing research group, and receiving a second offer of monetary payment from a governmental agency, in exchange for access to browsing activity data by persons of a particular demographic group to advertising and/or marketing companies interested in selling goods or services to persons of a particular demographic group, etc.), and establishing one or more use agreements between the data broker and one or more of the plurality of potential data consumers at 430 (e.g. entering into a first agreement to provide data on a daily basis to the marketing research group, and entering into a second agreement for a one-time sale of data gathered over a specified six-month period to the governmental agency, etc.).

As further shown in FIG. 6, in some implementations, providing a descriptor of the data product from the data broker to a plurality of potential data consumers (at 426) may include simultaneously providing a descriptor of the data product from the data broker to the plurality of potential data consumers at 432 (e.g. transmitting a description of available data to numerous recipients, posting a notice regarding an available data type on a message board, website, magazine advertisement, billboard, trade journal, or other suitable publication type, etc.). In further implementations, providing a descriptor of the data product from the data broker to a plurality of potential data consumers (at 426) may include providing a representative sample of the data product from the data broker to the plurality of potential data consumers at 434 (e.g. providing a representative sample of daily browsing history to a group of subscribers, providing a listing or partial listing of applications accessed during a specified period by a specified demographic group to potential data consumers, etc.).

In some implementations, establishing one or more use agreements between the data broker and one or more of the plurality of potential data consumers (at 430) may include establishing one or more non-exclusive use agreements between the data broker and one or more of the plurality of potential data consumers, each non-exclusive use agreement providing for a non-exclusive use of at least a portion of the data product at 436 (e.g. establishing a first use agreement with a first provider of services in a first field and establishing a second use agreement with a second provider of services in a second field, establishing first and second agreements with first and second service providers in first and second geographic regions, respectively, establishing a first license agreement with a first data consumer for a first type of data and establishing a second license agreement with a second data consumer for a second type of data, etc.). Furthermore, establishing one or more use agreements between the data broker and one or more of the plurality of potential data consumers (at 430) may include establishing an exclusive use agreement between the data broker and one of the plurality of potential data consumers, the exclusive use agreement providing for an exclusive use of at least a portion of the data product at 438 (e.g. establishing an exclusive license for work-hours browsing activity data by an aerospace engineering company's employees during a holiday shopping period, etc.).

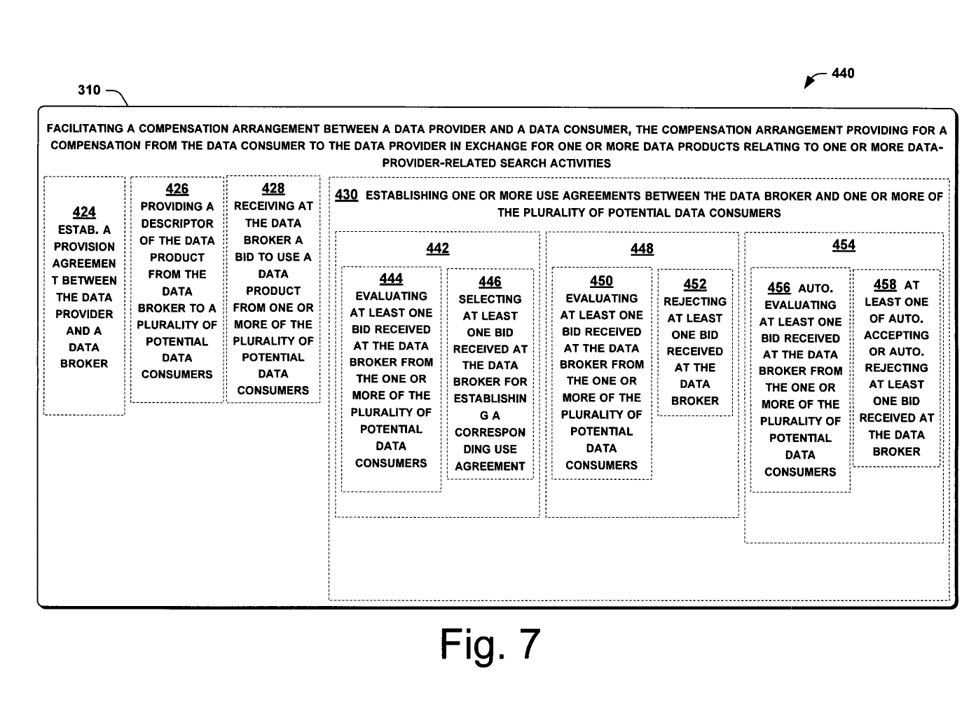

As shown in FIG. 7, in some implementations 440, establishing one or more use agreements between the data broker and one or more of the plurality of potential data consumers (at 430) may include, at 442, evaluating at least one bid received at the data broker from the one or more of the plurality of potential data consumers at 444 (e.g. determining whether a received bid meets or exceeds a minimum acceptable bid established for the data product, comparing a first received bid with a second received bid, determining whether a received bid comes from a bidder qualified to receive the data product under applicable regulations or policies, etc.), and selecting at least one bid received at the data broker for establishing a corresponding use agreement at 446 (e.g. selecting a highest bidder to enter into a suitable agreement for the data product, selecting all bids that meet an established set of criteria for entering use agreements, etc.).

In further implementations 440, establishing one or more use agreements between the data broker and one or more of the plurality of potential data consumers (at 430) may include, at 448, evaluating at least one bid received at the data broker from the one or more of the plurality of potential data consumers at 450 (e.g. determining that a bid for a specified data product has been presented by an entity that is owned by a foreign interest, determining that a bid for a specified data product has been presented by a competitor, etc.), and rejecting at least one bid received at the data broker at 452 (e.g. declining a bid presented by an entity that is owned by a foreign interest due to governmental export control regulations, declining a bid presented by a competitor based on company policies, etc.).

And in further implementations 440, establishing one or more use agreements between the data broker and one or more of the plurality of potential data consumers (at 430) may include, at 454, automatically evaluating at least one bid received at the data broker from the one or more of the plurality of potential data consumers at 456 (e.g. searching a database of prohibited potential data consumers using an automated software routine for a bidding entity, comparing one or more aspects of a bidding entities profile with a database of prohibited profiles using an automated software routine, etc.), and at least one of automatically accepting or automatically rejecting at least one bid received at the data broker at 458 (e.g. rejecting a bid from an entity that is identified with the database of prohibited potential data consumers, rejecting a bid if a bidder's profile information does not satisfy an established profile requirement, etc.).

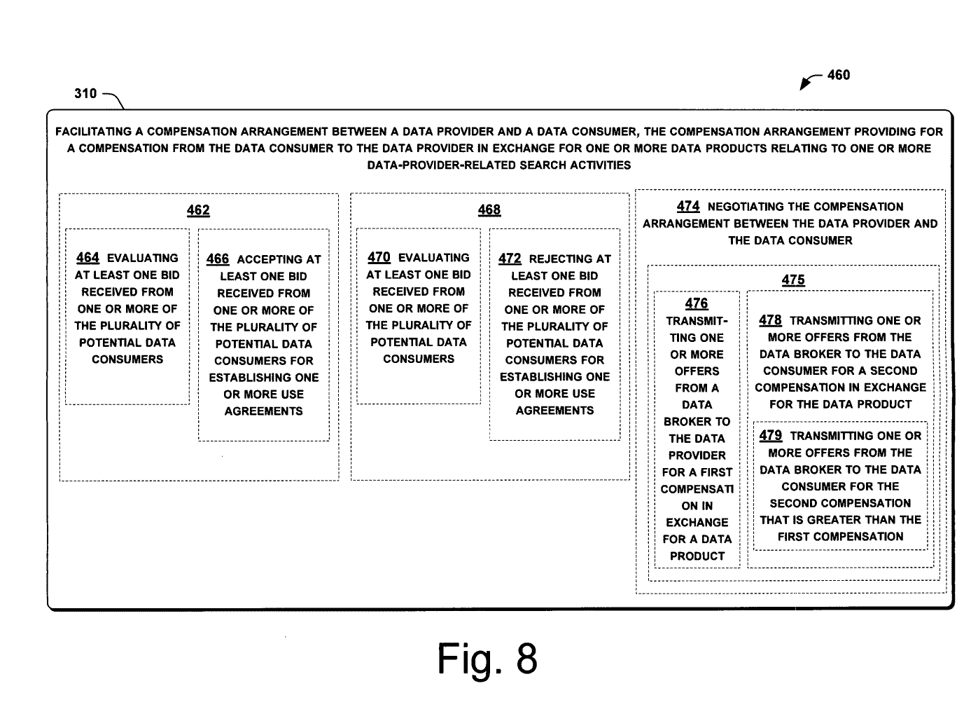

As shown in FIG. 8, in some implementations 460, facilitating a compensation arrangement between a data provider and a data consumer, the compensation arrangement providing for a compensation from the data consumer to the data provider in exchange for one or more data products relating to one or more data-provider-related search activities (at 310) may include, at 462, evaluating at least one bid received from one or more of the plurality of potential data consumers at 464 (e.g. determining that a bidder is not within a database of prohibited data consumers, determining that a bidding entities' profile information satisfies an acceptable profile, etc.), and accepting at least one bid received from one or more of the plurality of potential data consumers for establishing one or more use agreements at 466 (e.g. accepting an acceptable bidder's offer, acknowledging a conditional acceptance of a bidding entity's bid, etc.).

In further implementations 460, facilitating a compensation arrangement between a data provider and a data consumer, the compensation arrangement providing for a compensation from the data consumer to the data provider in exchange for one or more data products relating to one or more data-provider-related search activities (at 310) may include, at 468, evaluating at least one bid received from one or more of the plurality of potential data consumers at 470 (e.g. determining that a bidder is within a database of prohibited data consumers, determining that a bidder is partially or wholly owned by an entity that is within a database of prohibited data consumers, determining that a bidding entities' profile information does not satisfy a domestic ownership requirement of an established acceptable profile, etc.), and rejecting at least one bid received from one or more of the plurality of potential data consumers for establishing one or more use agreements at 472 (e.g. rejecting an unacceptable bidder's offer, conditionally rejecting an entity's bid subject to information verification or clarification, etc.).

With continued reference to FIG. 8, in some implementations 460, facilitating a compensation arrangement between a data provider and a data consumer, the compensation arrangement providing for a compensation from the data consumer to the data provider in exchange for one or more data products relating to one or more data-provider-related search activities (at 310) may include negotiating the compensation arrangement between the data provider and the data consumer at 474 (e.g. communicating a bidder's offer to a data provider, communicating the data provider's counter-offer to the bidder, and communicating the bidder's acceptance of the counter-offer to the data provider, rejecting a bidder's offer and/or providing a counter-offer to a bidder based on a comparison of the bidder's offer with a set of criteria established by a data provider, etc.). For example, in some implementations 460, negotiating the compensation arrangement between the data provider and the data consumer (at 474) may include, at 475, transmitting one or more offers from a data broker to the data provider for a first compensation in exchange for a data product at 476 (e.g. communicating first and second offers that meet or exceed a first level from first and second bidders to a data provider, communicating the five highest offers received to the data provider, etc.), and transmitting one or more offers from the data broker to the data consumer for a second compensation in exchange for the data product at 478 (e.g. communicating a third offer that meets or exceeds a second level to the data provider, communicating the next five highest offers received to the data provider, etc.). In at least some implementations, transmitting one or more offers from the data broker to the data consumer for a second compensation in exchange for the data product at 478 may include transmitting one or more offers from the data broker to the data consumer for the second compensation that is greater than the first compensation at 479 (e.g. transmitting a bid for a second compensation that exceeds a previously-transmitted bid for a first compensation, etc.).

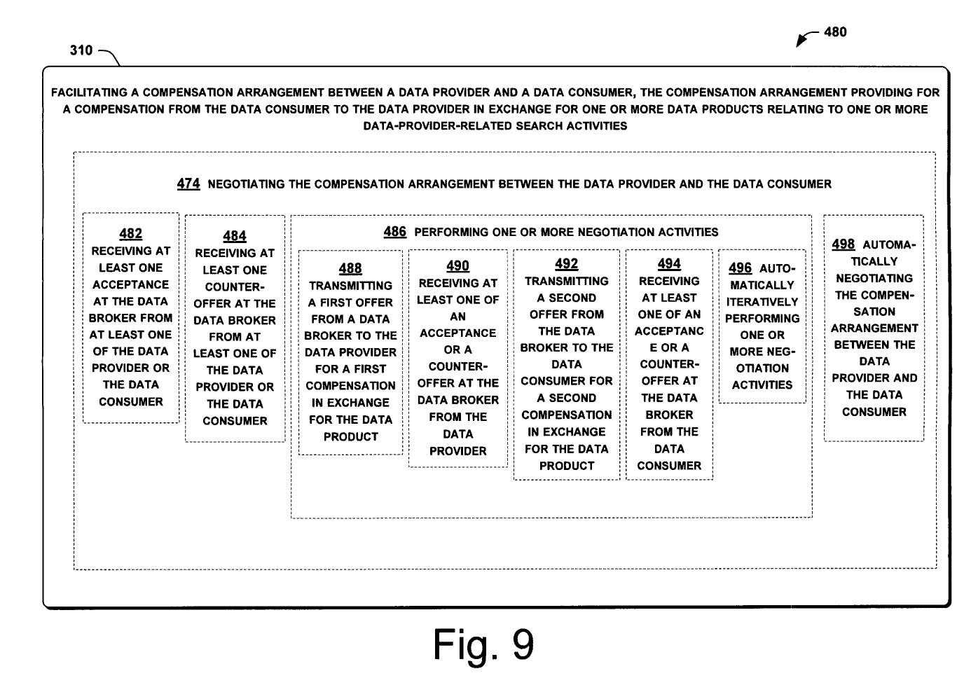

As shown in FIG. 9, in other implementations 480, negotiating the compensation arrangement between the data provider and the data consumer (at 474) may include receiving at least one acceptance at the data broker from at least one of the data provider or the data consumer at 482 (e.g. receiving an acceptance of a data provider's counter-offer from a bidder, receiving an acceptance from a data provider of a bidder's offer of compensation for use of a data product, etc.).

In further implementations 480, negotiating the compensation arrangement between the data provider and the data consumer (at 474) may include receiving at least one counter-offer at the data broker from at least one of the data provider or the data consumer at 484 (e.g. receiving a second counter-offer from a bidder to a data provider's first counter-offer, receiving a counter offer from a data provider to a bidder's offer, etc.).

In further implementations 480, negotiating the compensation arrangement between the data provider and the data consumer (at 474) may include, at 486, performing one or more negotiation activities, wherein performing one or more negotiation activities includes at least one of: transmitting a first offer from a data broker to the data provider for a first compensation in exchange for the data product at 488 (e.g. communicating an offer of a first compensation received by a data broker to the data provider, etc.); receiving at least one of an acceptance or a counter-offer at the data broker from the data provider at 490 (e.g. receiving a counter offer at the data broker from the data provider, etc.); transmitting a second offer from the data broker to the data consumer for a second compensation in exchange for the data product at 492 (e.g. communicating a second offer of a second compensation received by the data broker to the data provider, etc.); or receiving at least one of an acceptance or a counter-offer at the data broker from the data consumer at 494 (e.g. receiving an acceptance of the second offer at the data broker from the data provider, etc.).

Similarly, in further implementations 480, negotiating the compensation arrangement between the data provider and the data consumer (at 474) may include automatically iteratively performing one or more negotiation activities at 496 (e.g. for one or more offers that are not a highest offer, automatically counter-offer to provide the data product for a proposed compensation that exceeds the highest offer by a specified amount or percentage, and subsequently automatically decrease the proposed compensation in each subsequent counter-offer until the proposed compensation matches the highest offer, etc.). In still further implementations 480, negotiating the compensation arrangement between the data provider and the data consumer (at 474) may include automatically negotiating the compensation arrangement between the data provider and the data consumer at 498 (e.g. automatically accept all offers that exceed a predetermined threshold, automatically counter-offer to offers that fall within a specified range of a predetermined threshold, automatically reject bids that fall below a minimally acceptable threshold, etc.).

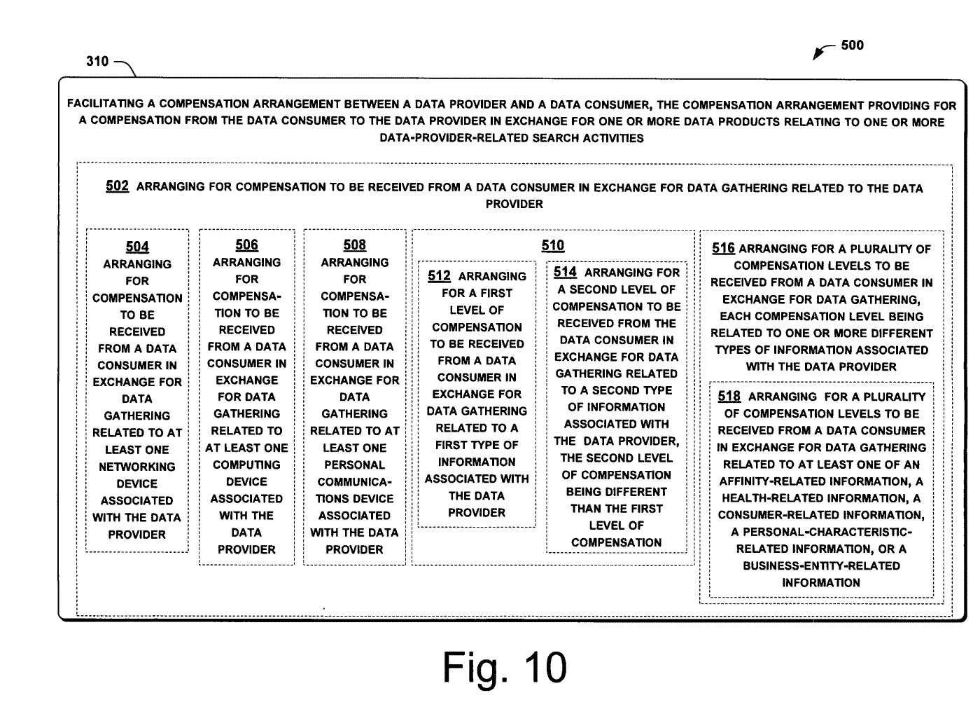

As shown in FIG. 10, in at least some implementations 500, facilitating a compensation arrangement between a data provider and a data consumer, the compensation arrangement providing for a compensation from the data consumer to the data provider in exchange for one or more data products relating to one or more data-provider-related search activities (at 310) may include arranging for compensation to be received from a data consumer in exchange for data gathering related to the data provider at 502 (e.g. establishing a payment plan for future data gathering activities by the data provider, establishing a monthly or quarterly subscription fee for monthly or quarterly data' provision, etc.). For example, in some implementations, arranging for compensation to be received from a data consumer in exchange for data gathering related to the data provider (at 502) may include arranging for compensation to be received from a data consumer in exchange for data gathering related to at least one networking device associated with the data provider at 504 (e.g. establishing a payment requirement for data on application usage activities using portable communication devices by a specified demographic group, etc.).

In further implementations, arranging for compensation to be received from a data consumer in exchange for data gathering related to the data provider (at 502) may include arranging for compensation to be received from a data consumer in exchange for data gathering related to at least one computing device associated with the data provider at 506 (e.g. establishing a payment requirement for laptop computer browsing activities by a specified demographic group, etc.).

In some implementations, arranging for compensation to be received from a data consumer in exchange for data gathering related to the data provider (at 502) may include arranging for compensation to be received from a data consumer in exchange for data gathering related to at least one personal communications device associated with the data provider at 508 (e.g. establishing a payment requirement for cellular telephone activities by college students on Friday nights, etc.).

As further shown in FIG. 10, in some implementations, arranging for compensation to be received from a data consumer in exchange for data gathering related to the data provider (at 502) may include, at 510, arranging for a first level of compensation to be received from a data consumer in exchange for data gathering related to a first type of information associated with the data provider at 512 (e.g. establishing a payment requirement of x dollars per thousand units of data associated with application-use activities for a specified demographic group, etc.), and arranging for a second level of compensation to be received from the data consumer in exchange for data gathering related to a second type of information associated with the data provider, the second level of compensation being different than the first level of compensation at 514 (e.g. establishing a payment requirement of 10× dollars per thousand units of data associated with music download or music purchase activities for the specified demographic group, etc.).

In further implementations, arranging for compensation to be received from a data consumer in exchange for data gathering related to the data provider (at 502) may include arranging for a plurality of compensation levels to be received from a data consumer in exchange for data gathering, each compensation level being related to one or more different types of information associated with the data provider at 516 (e.g. establishing a low-level payment requirement for data associated with time of day usage of hand-held communication devices by a specified demographic group, establishing a mid-level payment requirement for data associated with application usage by the specified demographic group, and establishing a high-level payment requirement for data associated with purchases by the specified demographic group, etc.). For example, in some implementations, arranging for a plurality of compensation levels to be received from a data consumer in exchange for data gathering, each compensation level being related to one or more different types of information associated with the data provider (at 516) may include arranging for a plurality of compensation levels to be received from a data consumer in exchange for data gathering related to at least one of an affinity-related information, a health-related information, a consumer-related information, a personal-characteristic-related information, or a business-entity-related information at 518.

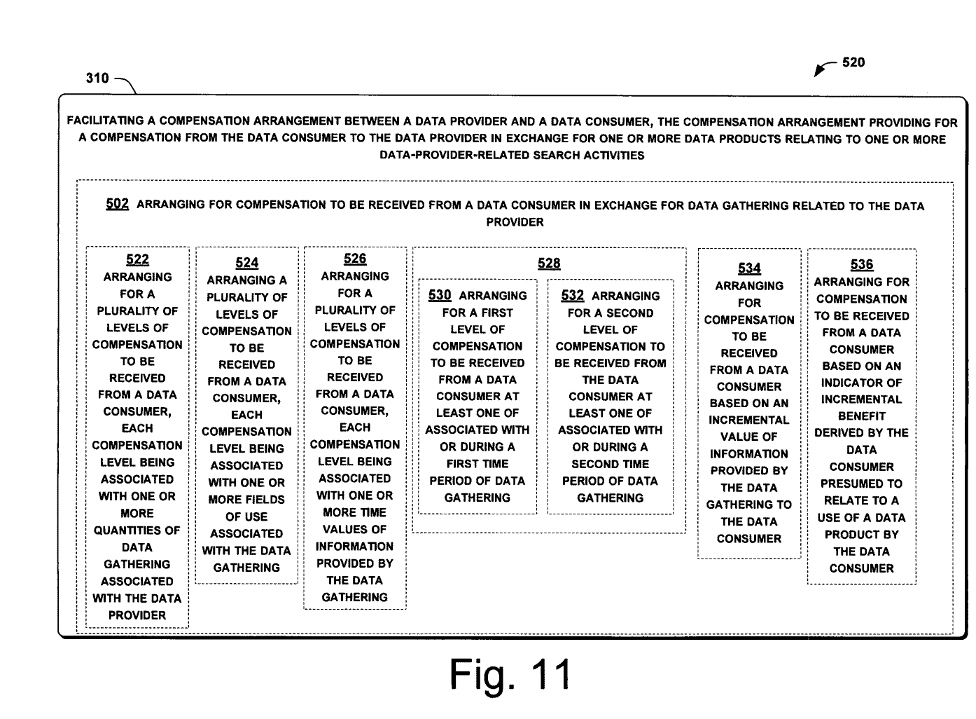

As shown in FIG. 11, in still other implementations 520, arranging for compensation to be received from a data consumer in exchange for data gathering related to the data provider (at 502) may include arranging for a plurality of levels of compensation to be received from a data consumer, each compensation level being associated with one or more quantities of data gathering associated with the data provider at 522 (e.g. establishing a payment requirement of x dollars per thousand units of data associated with application-use activities for a specified demographic group for a first five million units of data gathered, a requirement of x/5 dollars per thousand units of data for a next five million units of data gathered, and a requirement of x/10 dollars per thousand units of data for all additional data gathered, etc.).

Similarly, in some implementations, arranging for compensation to be received from a data consumer in exchange for data gathering related to the data provider (at 502) may include arranging for a plurality of levels of compensation to be received from a data consumer, each compensation level being associated with one or more fields of use associated with the data gathering at 524 (e.g. establishing a first payment level for data associated with a marketing field of use, a second payment level for data associated with a product development field of use, and a third payment level for data associated with an educational field of use, etc.).

In further implementations, arranging for compensation to be received from a data consumer in exchange for data gathering related to the data provider (at 502) may include arranging for a plurality of levels of compensation to be received from a data consumer, each compensation level being associated with one or more time values of information provided by the data gathering at 526 (e.g. establishing a first payment level for a most recent data, a second payment level for a slightly older data, and a third payment level for an oldest data, etc.).

With continued reference to FIG. 11, in some implementations, arranging for compensation to be received from a data consumer in exchange for data gathering related to the data provider (at 502) may include, at 528, arranging for a first level of compensation to be received from a data consumer at least one of associated with or during a first time period of data gathering at 530 (e.g. establishing a first payment level for data gathered during peak social networking hours, etc.), and arranging for a second level of compensation to be received from the data consumer at least one of associated with or during a second time period of data gathering at 532 (e.g. establishing a second payment level for data gathered during off-peak social networking hours, etc.).

In still other implementations, arranging for compensation to be received from a data consumer in exchange for data gathering related to the data provider (at 502) may include arranging for compensation to be received from a data consumer based on an incremental value of information provided by the data gathering to the data consumer at 534 (e.g. structuring compensation to the data provider to be a percentage of profit realized by the data consumer attributed to a use of the data gathered by the data provider, etc.).

In other implementations, arranging for compensation to be received from a data consumer in exchange for data gathering related to the data provider (at 502) may include arranging for compensation to be received from a data consumer based on an indicator of incremental benefit derived by the data consumer presumed to relate to a use of a data product by the data consumer at 536 (e.g. structuring compensation to the data provider to be based on increased sales, increased customers, or increased market share realized by the data consumer attributed to a use of the data gathered by the data provider, etc.).

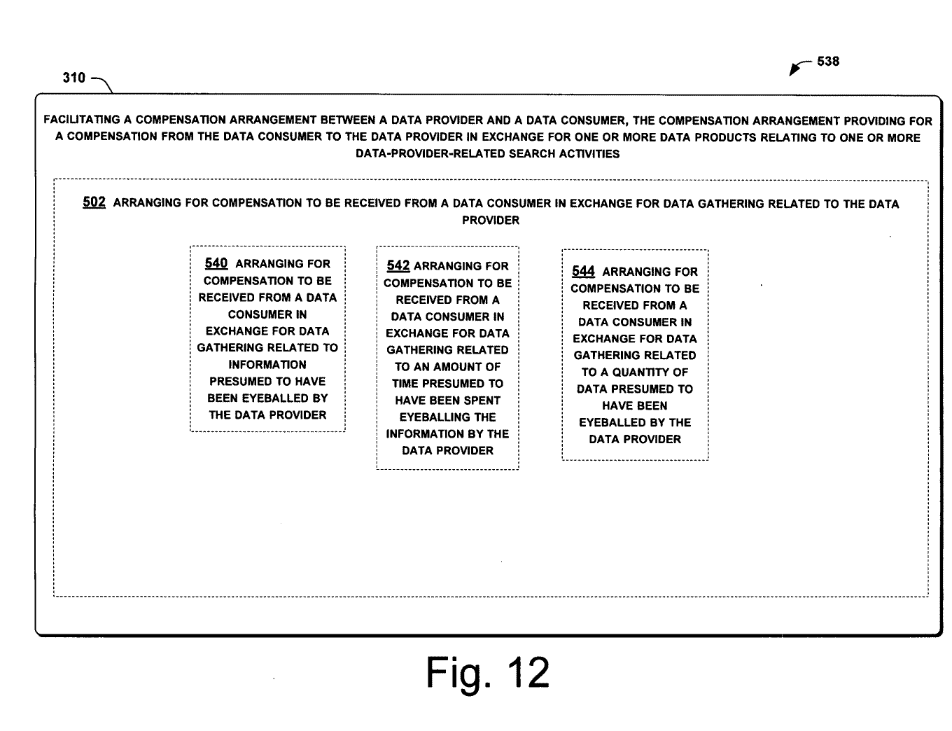

As depicted in FIG. 12, in some implementations 538, arranging for compensation to be received from a data consumer in exchange for data gathering related to the data provider (at 502) may include arranging for compensation to be received from a data consumer in exchange for data gathering related to information presumed to have been eyeballed by the data provider at 540 (e.g. structuring compensation based on a quantity of information presumed to have been read by the data provider, etc.).

In other implementations, arranging for compensation to be received from a data consumer in exchange for data gathering related to the data provider (at 502) may include arranging for compensation to be received from a data consumer in exchange for data gathering related to an amount of time presumed to have been spent eyeballing the information by the data provider at 542 (e.g. structuring compensation based on a time period that information is displayed to a display device, etc.).

And in further implementations, arranging for compensation to be received from a data consumer in exchange for data gathering related to the data provider (at 502) may include arranging for compensation to be received from a data consumer in exchange for data gathering related to a quantity of data presumed to have been eyeballed by the data provider at 544 (e.g. structuring compensation based on an amount of information that is displayed to a display device, etc.).

Generally, the activities associated with facilitating a compensation arrangement between a data provider and a data consumer, the compensation arrangement providing for a compensation from the data consumer to the data provider in exchange for one or more data products relating to one or more data-provider-related search activities (e.g. at 310 of the method 300 of FIG. 3) may be accomplished manually or semi-manually, or in an automated or semi-automated manner, and may use the communications 120 between the data providers 110 and the data broker 130, or the communications 150 between the data broker 130 and the data consumer 170, or both. Additionally, such activities may be accomplished via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems, and may be accomplished using any suitably operable couplings between the data broker 130 and the one or more data providers 110 and data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using computing devices (e.g. computing device 200, servers, laptops, mainframes, personal data assistants, cell phones, etc.), or using one or more components of such devices (e.g. processers 202, special purpose circuitry 282, application programs 232, other program modules 234, program data 236, network interface 252, wireless interface 255, serial port interface 242, other interfaces 216, 222, 228, etc.), or any other suitable systems or methods.

It should be appreciated that the particular embodiments of processes described herein are merely possible implementations of the present disclosure, and that the present disclosure is not limited to the particular implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

Various methods, systems, and techniques may be described and implemented in the general context of computer-executable instructions, such as program modules, executed by one or more processors or other devices. Generally, program modules include routines, programs, objects, components, data structures, etc. that perform particular tasks or implement particular abstract data types. Typically, the functionality of the program modules may be combined or distributed as desired in various alternate embodiments. In addition, embodiments of these methods, systems, and techniques may be stored on or transmitted across some form of computer readable media.

It may also be appreciated that there may be little distinction between hardware and software implementations of aspects of systems and methods disclosed herein. The use of hardware or software may generally be a design choice representing cost vs. efficiency tradeoffs, however, in certain contexts the choice between hardware and software can become significant. Those having skill in the art will appreciate that there are various vehicles by which processes, systems, and technologies described herein can be effected (e.g., hardware, software, firmware, or combinations thereof), and that a preferred vehicle may vary depending upon the context in which the processes, systems, and technologies are deployed. For example, if an implementer determines that speed and accuracy are paramount, the implementer may opt for a mainly hardware and/or firmware vehicle. Alternatively, if flexibility is paramount, the implementer may opt for a mainly software implementation. In still other implementations, the implementer may opt for some combination of hardware, software, and/or firmware. Hence, there are several possible vehicles by which the processes and/or devices and/or other technologies described herein may be effected, and which may be desired over another may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use standard engineering practices to integrate such described devices and/or processes into workable systems having the described functionality. That is, at least a portion of the devices and/or processes described herein can be developed into a workable system via a reasonable amount of experimentation.

The herein described aspects and drawings illustrate different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” (or “operatively connected,” or “operatively coupled”) to each other to achieve the desired functionality, and any two components capable of being so associated can also be viewed as being “operably couplable” (or “operatively couplable”) to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that some aspects of the embodiments disclosed herein can be implemented in standard integrated circuits, and also as one or more computer programs running on one or more computers, and also as one or more software programs running on one or more processors, and also as firmware, as well as virtually any combination thereof. It will be further understood that designing the circuitry and/or writing the code for the software and/or firmware could be accomplished by a person skilled in the art in light of the teachings and explanations of this disclosure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. For example, in some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

As a further example of “open” terms in the present specification and claims, it will be understood that usage of a language construction “A or B” is generally interpreted as a non-exclusive “open term” meaning: A alone, B alone, and/or A and B together.

Although various features have been described in considerable detail with reference to certain preferred embodiments, other embodiments are possible. Therefore, the spirit or scope of the appended claims should not be limited to the description of the embodiments contained herein.

1. A method at least partially implemented in a computer, comprising:
facilitating a compensation arrangement between a data provider and a data consumer, the compensation arrangement providing for a compensation from the data consumer to the data provider in exchange for one or more data products relating to one or more data-provider-related search activities, including:
offering the one or more data products to a plurality of potential data consumers for bid by the plurality of potential data consumers.

2. The method of claim 1, wherein offering the one or more data products to a plurality of potential data consumers for bid by the plurality of potential data consumers comprises:
simultaneously offering the one or more data products to a plurality of potential data consumers for bid by the plurality of potential data consumers.

3. The method of claim 1, wherein offering the one or more data products to a plurality of potential data consumers for bid by the plurality of potential data consumers comprises:
offering the one or more data products to the plurality of potential data consumers, each potential data consumer subscribing to a subscription service to receive offers of data products.

4. The method of claim 1, wherein facilitating a compensation arrangement between a data provider and a data consumer, the compensation arrangement providing for a compensation from the data consumer to the data provider in exchange for one or more data products relating to one or more data-provider-related search activities further comprises:
receiving at least one bid for the one or more data products from one or more of the plurality of potential data consumers.

5. (canceled)

6. The method of claim 1, wherein facilitating a compensation arrangement between a data provider and a data consumer, the compensation arrangement providing for a compensation from the data consumer to the data provider in exchange for one or more data products relating to one or more data-provider-related search activities comprises:
establishing at least one use agreement with at least one bidder from the plurality of potential data consumers.

7. The method of claim 6, wherein establishing at least one use agreement with at least one bidder from the plurality of potential data consumers comprises:
accepting one or more of a plurality of bids for the data product.

8. (canceled)

9. (canceled)

10. The method of claim 1, wherein facilitating a compensation arrangement between a data provider and a data consumer, the compensation arrangement providing for a compensation from the data consumer to the data provider in exchange for one or more data products relating to one or more data-provider-related search activities comprises:
establishing a provision agreement between the data provider and a data broker;
providing a descriptor of the data product from the data broker to a plurality of potential data consumers;
receiving at the data broker a bid to use a data product from one or more of the plurality of potential data consumers; and
establishing one or more use agreements between the data broker and one or more of the plurality of potential data consumers.

11. (canceled)

12. (canceled)

13. (canceled)

14. (canceled)

15. The method of claim 10, wherein establishing one or more use agreements between the data broker and one or more of the plurality of potential data consumers comprises:
evaluating at least one bid received at the data broker from the one or more of the plurality of potential data consumers; and
selecting at least one bid received at the data broker for establishing a corresponding use agreement.

16. (canceled)

17. The method of claim 10, wherein establishing one or more use agreements between the data broker and one or more of the plurality of potential data consumers comprises:
automatically evaluating at least one bid received at the data broker from the one or more of the plurality of potential data consumers; and
at least one of automatically accepting or automatically rejecting at least one bid received at the data broker.

18. (canceled)

19. (canceled)

20. The method of claim 1, wherein facilitating a compensation arrangement between a data provider and a data consumer, the compensation arrangement providing for a compensation from the data consumer to the data provider in exchange for one or more data products relating to one or more data-provider-related search activities comprises:
negotiating the compensation arrangement between the data provider and the data consumer.

21. The method of claim 20, wherein negotiating the compensation arrangement between the data provider and the data consumer comprises:
transmitting one or more offers from a data broker to the data provider for a first compensation in exchange for a data product; and
transmitting one or more offers from the data broker to the data consumer for a second compensation in exchange for the data product.

22. (canceled)

23. (canceled)

24. The method of claim 20, wherein negotiating the compensation arrangement between the data provider and the data consumer comprises:
receiving at least one counter-offer at the data broker from at least one of the data provider or the data consumer.

25. (canceled)

26. The method of claim 20, wherein negotiating the compensation arrangement between the data provider and the data consumer comprises:
automatically iteratively performing one or more negotiation activities.

27. (canceled)

28. The method of claim 1, wherein facilitating a compensation arrangement between a data provider and a data consumer, the compensation arrangement providing for a compensation from the data consumer to the data provider in exchange for one or more data products relating to one or more data-provider-related search activities comprises:
arranging for compensation to be received from a data consumer in exchange for data gathering related to the data provider.

29. The method of claim 28, wherein arranging for compensation to be received from a data consumer in exchange for data gathering related to the data provider comprises:
arranging for compensation to be received from a data consumer in exchange for data gathering related to at least one networking device associated with the data provider.

30. (canceled)

31. The method of claim 28, wherein arranging for compensation to be received from a data consumer in exchange for data gathering related to the data provider comprises:
arranging for compensation to be received from a data consumer in exchange for data gathering related to at least one personal communications device associated with the data provider.

32. The method of claim 28, wherein arranging for compensation to be received from a data consumer in exchange for data gathering related to the data provider comprises:
arranging for a first level of compensation to be received from a data consumer in exchange for data gathering related to a first type of information associated with the data provider; and
arranging for a second level of compensation to be received from the data consumer in exchange for data gathering related to a second type of information associated with the data provider, the second level of compensation being different than the first level of compensation.

33. The method of claim 28, wherein arranging for compensation to be received from a data consumer in exchange for data gathering related to the data provider comprises:
arranging for a plurality of compensation levels to be received from a data consumer in exchange for data gathering, each compensation level being related to one or more different types of information associated with the data provider.

34. The method of claim 33, wherein arranging for a plurality of compensation levels to be received from a data consumer in exchange for data gathering, each compensation level being related to one or more different types of information associated with the data provider comprises:
arranging for a plurality of compensation levels to be received from a data consumer in exchange for data gathering related to at least one of an affinity-related information, a health-related information, a consumer-related information, a personal-characteristic-related information, or a business-entity-related information.

35. The method of claim 28, wherein arranging for compensation to be received from a data consumer in exchange for data gathering related to the data provider comprises:
arranging for a plurality of levels of compensation to be received from a data consumer, each compensation level being associated with one or more quantities of data gathering associated with the data provider.

36. The method of claim 28, wherein arranging for compensation to be received from a data consumer in exchange for data gathering related to the data provider comprises:
arranging for a plurality of levels of compensation to be received from a data consumer, each compensation level being associated with one or more fields of use associated with the data gathering.

37. The method of claim 28, wherein arranging for compensation to be received from a data consumer in exchange for data gathering related to the data provider comprises:
arranging for a plurality of levels of compensation to be received from a data consumer, each compensation level being associated with one or more time values of information provided by the data gathering.

38. The method of claim 28, wherein arranging for compensation to be received from a data consumer in exchange for data gathering related to the data provider comprises:
arranging for a first level of compensation to be received from a data consumer at least one of associated with or during a first time period of data gathering; and
arranging for a second level of compensation to be received from the data consumer at least one of associated with or during a second time period of data gathering.

39. The method of claim 28, wherein arranging for compensation to be received from a data consumer in exchange for data gathering related to the data provider comprises:
arranging for compensation to be received from a data consumer based on an incremental value of information provided by the data gathering to the data consumer.

40. The method of claim 28, wherein arranging for compensation to be received from a data consumer in exchange for data gathering related to the data provider comprises:
arranging for compensation to be received from a data consumer based on an indicator of incremental benefit derived by the data consumer presumed to relate to a use of a data product by the data consumer.

41. The method of claim 28, wherein arranging for compensation to be received from a data consumer in exchange for data gathering related to the data provider comprises:
arranging for compensation to be received from a data consumer in exchange for data gathering related to information presumed to have been eyeballed by the data provider.

42. The method of claim 41, wherein arranging for compensation to be received from a data consumer in exchange for data gathering related to information presumed to have been eyeballed by the data provider comprises:
arranging for compensation to be received from a data consumer in exchange for data gathering related to an amount of time presumed to have been spent eyeballing the information by the data provider.

43. The method of claim 41, wherein arranging for compensation to be received from a data consumer in exchange for data gathering related to information presumed to have been eyeballed by the data provider comprises:
arranging for compensation to be received from a data consumer in exchange for data gathering related to a quantity of data presumed to have been eyeballed by the data provider.

44. (canceled)

45. (canceled)

46. (canceled)

47. (canceled)

48. An apparatus, comprising:
means for facilitating a compensation arrangement between a data provider and a data consumer, the compensation arrangement providing for a compensation from the data consumer to the data provider in exchange for one or more data products relating to one or more data-provider-related search activities, including:
means for offering the one or more data products to a plurality of potential data consumers for bid by the plurality of potential data consumers.

49. (canceled)

50. (canceled)

51. (canceled)

52. (canceled)

53. (canceled)

54. (canceled)

55. (canceled)

56. (canceled)

57. The apparatus of claim 48, wherein means for facilitating a compensation arrangement between a data provider and a data consumer, the compensation arrangement providing for a compensation from the data consumer to the data provider in exchange for one or more data products relating to one or more data-provider-related search activities comprises:
means for establishing a provision agreement between the data provider and a data broker;
means for providing a descriptor of the data product from the data broker to a plurality of potential data consumers;
means for receiving at the data broker a bid to use a data product from one or more of the plurality of potential data consumers; and
means for establishing one or more use agreements between the data broker and one or more of the plurality of potential data consumers.

58. (canceled)

59. (canceled)

60. (canceled)

61. (canceled)

62. The apparatus of claim 57, wherein means for establishing one or more use agreements between the data broker and one or more of the plurality of potential data consumers comprises:
means for evaluating at least one bid received at the data broker from the one or more of the plurality of potential data consumers; and
means for selecting at least one bid received at the data broker for establishing a corresponding use agreement.

63. (canceled)

64. The apparatus of claim 57, wherein means for establishing one or more use agreements between the data broker and one or more of the plurality of potential data consumers comprises:
means for automatically evaluating at least one bid received at the data broker from the one or more of the plurality of potential data consumers; and
means for at least one of automatically accepting or automatically rejecting at least one bid received at the data broker.

65. (canceled)

66. (canceled)

67. (canceled)

68. (canceled)

69. (canceled)

70. (canceled)

71. (canceled)

72. (canceled)

73. The apparatus of claim 48 72, wherein means for facilitating a compensation arrangement between a data provider and a data consumer comprises:
means for automatically iteratively performing one or more negotiation activities.

74. (canceled)

75. The apparatus of claim 48, wherein means for facilitating a compensation arrangement between a data provider and a data consumer, the compensation arrangement providing for a compensation from the data consumer to the data provider in exchange for one or more data products relating to one or more data-provider-related search activities comprises:
means for arranging for compensation to be received from a data consumer in exchange for data gathering related to the data provider.

76. (canceled)

77. (canceled)

78. (canceled)

79. The apparatus of claim 75, wherein means for arranging for compensation to be received from a data consumer in exchange for data gathering related to the data provider comprises:
means for arranging for a first level of compensation to be received from a data consumer in exchange for data gathering related to a first type of information associated with the data provider; and
means for arranging for a second level of compensation to be received from the data consumer in exchange for data gathering related to a second type of information associated with the data provider, the second level of compensation being different than the first level of compensation.

80. (canceled)

81. (canceled)

82. (canceled)

83. (canceled)

84. The apparatus of claim 75, wherein means for arranging for compensation to be received from a data consumer in exchange for data gathering related to the data provider comprises:
means for arranging for a plurality of levels of compensation to be received from a data consumer, each compensation level being associated with one or more time values of information provided by the data gathering.

85. The apparatus of claim 75, wherein means for arranging for compensation to be received from a data consumer in exchange for data gathering related to the data provider comprises:
means for arranging for a first level of compensation to be received from a data consumer at least one of associated with or during a first time period of data gathering; and
means for arranging for a second level of compensation to be received from the data consumer at least one of associated with or during a second time period of data gathering.

86. The apparatus of claim 75, wherein means for arranging for compensation to be received from a data consumer in exchange for data gathering related to the data provider comprises:
means for arranging for compensation to be received from a data consumer based on an incremental value of information provided by the data gathering to the data consumer.

87. (canceled)

88. (canceled)

89. The apparatus of claim 75, wherein means for arranging for compensation to be received from a data consumer in exchange for data gathering related to the data provider comprises:
means for arranging for compensation to be received from a data consumer in exchange for data gathering related to an amount of time presumed to have been spent eyeballing the information by the data provider.

90. The apparatus of claim 75, wherein means for arranging for compensation to be received from a data consumer in exchange for data gathering related to the data provider comprises:
means for arranging for compensation to be received from a data consumer in exchange for data gathering related to a quantity of data presumed to have been eyeballed by the data provider.

91. (canceled)

92. (canceled)

93. (canceled)

94. (canceled)

95. (canceled)

96. One or more signal-bearing media bearing one or more instructions that, when executed by an executing component, perform a method comprising:
facilitating a compensation arrangement between a data provider and a data consumer, the compensation arrangement providing for a compensation from the data consumer to the data provider in exchange for one or more data products relating to one or more data-provider-related search activities, including offering the one or more data products to a plurality of potential data consumers for bid by the plurality of potential data consumers.

97. A system, comprising:
an executing component;
a memory operatively coupled to the executing component; and
an arrangements component accessible by the executing component, the arrangements component being operable to facilitate a compensation arrangement between a data provider and a data consumer regarding one or more data-provider-related search activities, and the arrangements component being operable to offer the one or more data products to a plurality of potential data consumers for bid by the plurality of potential data consumers.

98. (canceled)

99. (canceled)
